(19) United States
(12) Patent Application Publication
(10) Pub. No.: US 2014/0264216 A1
(43) Pub. Date: Sep. 18, 2014

(54) Handle System

(71) Applicant: Richard C. Mendoza, Henderson, NV (US)

(72) Inventor: Richard C. Mendoza, Henderson, NV (US)

(21) Appl. No.: 13/843,495

(22) Filed: Mar. 15, 2013

(51) Int. Cl. B66F 3/25

(52) U.S. Cl. CPC B66F 3/25
USPC 254/93 R

(57) ABSTRACT

A handle system that securely joins a handle to a lifting assembly when the lifting assembly is not in use. The handle detachably joins with a lift portion of the lifting assembly and manipulates the lift portion to operate the lifting assembly. After use, the handle detaches from the lift portion and joins with a handle storage portion. The handle storage portion includes a solid rod that receives the handle and securely fastens to the handle. The outer diameter of the handle storage portion is fractionally smaller than the inner diameter of the handle, thereby creating a snug fit. The handle also includes an aperture that receives a tab or a ring that extend from the handle storage portion to further fasten the handle to the lifting assembly.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to lifting assemblies. More particularly, the invention relates to joining handles with lifting assemblies.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a jack is a mechanical device used as a lifting device to lift heavy loads or apply great forces. Jacks employ a screw thread or hydraulic cylinder to apply very high linear forces.

Typically, a mechanical jack is a device which lifts heavy equipment. The most common form is a car jack, floor jack or garage jack which lifts vehicles so that maintenance can be performed. More powerful jacks use hydraulic power to provide more lift over greater distances.

Typically, a handle is a part of, or attachment to, an object that can be moved or used by hand, such as a jack. The design of each type of handle involves substantial ergonomic issues, even where these are dealt with intuitively or by following tradition. Handles for tools are an important part of their function, enabling the user to exploit the tools to maximum effect.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary handle system, in accordance with an embodiment of the present invention;

FIGS. 2A and 2B illustrate detailed perspective views of an exemplary handle system, where FIG. 2A illustrates an exemplary handle portion detached from an exemplary handle storage portion, and FIG. 2B illustrates an exemplary handle portion joined with an exemplary handle storage portion, in accordance with an embodiment of the present invention;

FIG. 3 illustrates a detailed perspective view of an exemplary handle storage portion with a threaded neck section in position to join with an exemplary base portion with a threaded female section, in accordance with an embodiment of the present invention;

FIGS. 4A and 4B illustrate detailed perspective views of an exemplary handle portion with an exemplary aperture for securing to an exemplary handle storage portion with an exemplary protruding portion, where FIG. 4A illustrates an exemplary spring loaded tab on the handle storage portion, and FIG. 4B illustrates an exemplary rubber ring on the handle storage portion, in accordance with an embodiment of the present invention; and

FIG. 5 illustrates a detailed perspective view of an exemplary handle system supporting an exemplary object, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of handle systems used with lifting assemblies that may be provided by preferred embodiments of the present invention. In one embodiment of the present invention, the handle system may securely join a handle portion to a lifting assembly when the lifting assembly is not in use. Those skilled in the art, in light of the present teachings, will recognize that the lifting assembly may exert a large linear force to support or move a heavy object. The lifting assembly may require the leverage and grip that the handle portion provides to operate effectively. When in use, the handle portion may join with a lift portion of the lifting assembly. The lift portion may be manipulated by the handle portion to move an object. In some embodiments, the lifting assembly may securely fasten the handle portion directly on the lifting assembly while not in use. A variety of fastener may provide a secure connection between the lifting assembly and the handle portion. In this manner, the handle portion may not easily separate or be lost from the lifting assembly.

In one embodiment of the present invention, the lifting assembly may include, without limitation, a hydraulic bottle jack, a pneumatic jack, a house jack, and a strand jack. The lifting assembly may include a base portion that rests on a surface for providing stability to the lifting assembly while engaging an object. A mounting portion may extend and retract from the lifting assembly to engage the object. In this manner, when the lifting assembly positions against an object surface, the mounting portion may press against the object surface. In some embodiments, the lifting assembly may include a lift portion that is operable to be manipulated for extending and retracting the mounting portion. Those skilled in the art, in light of the present teachings, will recognize that the object to be moved by the lifting assembly may be heavy. Adequate leverage and grip may be required to operate the lifting assembly when moving heavy objects. An extension, such as a handle or lever may facilitate manipulation of the lift portion. In some embodiments, a handle portion may join with the lift portion for providing leverage and facilitating the manipulation of the lift portion. In some embodiments, a handle storage portion may extend from the base portion. The handle storage portion may include a solid rod configured to receive the handle portion. In some embodiments, the handle portion may include a hollow rod that at least partially encloses the handle storage portion. The handle portion may include an inner diameter that is fractionally larger than an outer diameter of the handle storage portion. In this manner, the handle portion and the handle storage portion may join by sliding together. In some embodiments, a protruding portion on the handle storage portion may secure with an aperture on the handle portion. However, in other embodiments, other fasteners for the handle portion and the handle storage portion may include, without limitation, a threaded screw and aperture, a spring loaded tab that engages an aperture, a rubber ring that extends from the handle storage assembly, and a magnet. Those skilled in the art, in light of the present teachings, will recognize that fastening the handle portion to the handle storage portion may provide an additional layer of security to the handle portion sliding into the handle storage portion.

FIG. 1 illustrates a detailed perspective view of an exemplary handle system, in accordance with an embodiment of the present invention. In the present invention, a handle system 100 may securely join a handle portion 114 to a lifting assembly 102 when the lifting assembly is not in use. Those skilled in the art, in light of the present teachings, will recognize that the lifting assembly may exert a large linear force to support or move a heavy object. The lifting assembly may require the leverage and grip that the handle portion provides to operate effectively. When in use, the handle portion may join with a lift portion 106. In this manner, the lift portion may be manipulated by the handle portion to move an object. Possible manipulations of the handle portion may include, without limitation, cranking up and down, rotating, extending, retracting, and automated movements. In some embodiments, the lifting assembly may securely fasten the handle portion directly on the lifting assembly while not in use. A variety of fastener may provide a secure connection between the lifting assembly and the handle portion. In this manner, the handle portion may not easily separate or be lost from the lifting assembly. In one alternative embodiment, the handle portion may include an audio portion for alerting when beyond a predetermined range from the lifting assembly.

In one embodiment of the present invention, the lifting assembly may include, without limitation, a hydraulic bottle jack, a pneumatic jack, a house jack, and a strand jack. The lifting assembly may include a base portion 104 that rests on a surface for providing stability to the lifting assembly while engaging an object. A mounting portion 108 may extend and retract from the lifting assembly to engage the object. In this manner, when the lifting assembly positions against an object surface, the mounting portion may press against the object surface. In some embodiments, the lifting assembly may include a lift portion that is operable to be manipulated for extending and retracting the mounting portion. Those skilled in the art, in light of the present teachings, will recognize that the object to be moved by the lifting assembly may be heavy. Adequate leverage and grip may be required to operate the lifting assembly when moving heavy objects. An extension, such as a handle or lever may facilitate manipulation of the lift portion. In some embodiments, a handle portion may join with the lift portion for providing leverage and facilitating the manipulation of the lift portion. In some embodiments, a handle storage portion 110 may extend from the base portion. The handle storage portion may include a solid rod configured to receive the handle portion. In some embodiments, the handle portion may include a hollow rod that at least partially encloses the handle storage portion. The handle portion may include an inner diameter that is fractionally larger than an outer diameter of the handle storage portion. In this manner, the handle portion and the handle storage portion may join by sliding together. In some embodiments, a protruding portion on the handle storage portion may secure with an aperture on the handle portion. However, in other embodiments, other fasteners for the handle portion and the handle storage portion may include, without limitation, a threaded screw and aperture, a spring loaded tab that engages an aperture, a rubber ring that extends from the handle storage assembly, and a magnet. Those skilled in the art, in light of the present teachings, will recognize that fastening the handle portion to the handle storage portion may provide an additional layer of security to the handle portion sliding into the handle storage portion. In some embodiments, the lifting assembly may include a carrying portion 112 configured to be operable for a hand to grasp and move the lifting assembly when not in use. Suitable materials for fabricating the handle system, may include, without limitation, steel, metal alloys, aluminum, titanium, polyvinyl chloride, and polymers.

FIGS. 2A and 2B illustrate detailed perspective views of an exemplary handle system, where FIG. 2A illustrates an exemplary handle portion detached from an exemplary handle storage portion, and FIG. 2B illustrates an exemplary handle portion joined with an exemplary handle storage portion, in accordance with an embodiment of the present invention. In the present invention, an extension, such as a handle or lever, may facilitate manipulation of the lift portion. In some embodiments, a handle portion may detachably join with the lift portion. The handle portion may detach from the lift portion to save space during storage. However, in another embodiment, the handle portion may remain joined with the lift portion during storage. In one alternative embodiment, the handle portion may remain joined with the lift portion, yet collapse in half at a hinge. The handle portion may be ergonomically designed for enhanced comfort and grip. In one embodiment, two handle storage portions may extend from the base portion to join with a two-piece handle.

FIG. 3 illustrates a detailed perspective view of an exemplary handle storage portion with a threaded neck section in position to join with an exemplary base portion with a threaded female section, in accordance with an embodiment of the present invention. In the present invention the handle storage portion may include a threaded neck section 302 that extends through a threaded female section 304 of the base portion, wherein rotation of the handle portion in a first direction urges the handle portion downwardly into engagement with the handle storage portion. The engagement may create a secure attachment between the liquid dispenser body and the food dispenser body. However, in some embodiments, the handle portion may be manufactured with the lifting assembly. In other embodiments, the handle portion may be universal so as to be utilized on a variety of lifting assemblies. In some embodiments, the handle storage portion may be configured to secure to the base portion in a substantially vertical position. However, in other embodiments, the handle storage portion may join other sections of the lifting assembly in different orientations, including, without limitation, a substantially horizontal position from a central section of the lifting assembly, an angled position extending from the base portion, and a pair of handle storage portions that extend from two sides of the lifting assembly. In one alternative embodiment, the handle storage portion may telescopically extend and retract from the base portion. In yet another alternative embodiment, the handle storage portion may include a rod that extends vertically from the base portion for twelve inches, and then angles outwardly to a forty-five degree angle for an additional twelve inches. In this manner, a bendable handle portion may conform to the angled rod for forming a tighter attachment with the rod.

FIGS. 4A and 4B illustrate detailed perspective views of an exemplary handle portion with an exemplary aperture for securing to an exemplary handle storage portion with an exemplary protruding portion, where FIG. 4A illustrates an exemplary spring loaded tab on the handle storage portion, and FIG. 4B illustrates an exemplary rubber ring on the handle storage portion, in accordance with an embodiment of the present invention. In the present invention, the handle portion may utilize a variety of fastening mechanisms for securely attaching to the handle storage portion. In one embodiment, the handle portion may include an aperture 402. The aperture may be configured to enable at least partial passage of a protruding portion 404 of the handle storage portion. The protruding portion may include, without limitation, a spring loaded tab, a rubber ring, and a plurality of ridges. In this manner, the frictional engagement between the handle portion and the handle storage portion may form a secure attachment.

In one embodiment of the present invention, the handle storage portion may include a small rubber ring that projects from the circumference. The rubber ring may position in proximity to the base portion. The handle may be forced down over the rubber ring. In this manner, the ring may engage the interior of the handle portion and secure into place, so even if the lifting assembly tips over, the handle portion may remain on the handle storage portion. Those skilled in the art, in light of the present teachings, will recognize that a small force may be utilized to force the handle portion on and off the handle storage portion. In yet another embodiment, the handle portion may include the aperture and the handle storage portion may include a spring loaded tab. When the handle portion joins with the handle storage portion, the spring loaded tab may project through the aperture to secure the handle portion in place. Pressing the spring loaded tab and pulling the handle portion may allow the handle portion to be removed.

FIG. 5 illustrates a detailed perspective view of an exemplary handle system supporting an exemplary object, in accordance with an embodiment of the present invention. In the present invention, the lifting assembly may lift and lower an object 502. The object may include, without limitation, a vehicle, a wall, a steel beam, and a rock. The object may be heavy and require a heavy linear force to support or move. A handle portion may facilitate the manipulation of the lifting assembly while moving the object.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a detachable handle for a lifting assembly according to the present invention will be apparent to those skilled in the art. Various aspects of the invention have been described above by way of illustration, and the specific embodiments disclosed are not intended to limit the invention to the particular forms disclosed. The particular implementation of the detachable handle for a lifting assembly may vary depending upon the particular context or application. By way of example, and not limitation, the arms that extend from the detachable handle for a lifting assembly described in the foregoing were principally directed to a location on a lifting assembly for storing a handle implementations; however, similar techniques may instead be applied to handles and levers for all machines, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a lifting assembly, said lifting assembly being configured to apply a force on an object, said lifting assembly comprising a lift portion, said lift portion being configured to operate said lifting assembly, said lifting assembly further comprising a handle storage portion; and
a handle portion, said handle portion being configured to detachably join with said lift portion, said handle portion being operable to manipulate said lift portion, said handle portion further being configured to detachably join with said handle storage portion.

2. The system of claim 1, in which said system comprises a handle system.

3. The system of claim 1, in which said lifting assembly comprises a pneumatic jack.

4. The system of claim 1, in which said lifting assembly comprises a base portion, said base portion being configured to rest on a surface, said base portion comprising a threaded female section.

5. The system of claim 4, wherein said handle storage portion is configured to extend vertically from said base portion.

6. The system of claim 1, in which said handle storage portion comprises a threaded neck section, said threaded neck section being configured to be urged through said threaded female section.

7. The system of claim 1, in which said handle storage portion comprises a solid rod, said solid rod comprising an outer diameter.

8. The system of claim 1, in which said handle storage portion comprises a protruding portion.

9. The system of claim 8, in which said protruding portion comprises a spring loaded tab.

10. The system of claim 1, in which said handle portion comprises a hollow rod.

11. The system of claim 1, wherein said handle portion is operable to slidably join with said handle storage portion.

12. The system of claim 7, in which said handle portion comprises an inner diameter fractionally smaller than said outer diameter.

13. The system of claim 1, in which said handle portion comprises an aperture.

14. The system of claim 13, wherein said aperture is configured to at least partially receive said protruding portion.

15. The system of claim 1, in which said lifting assembly comprises a mounting portion,

16. The system of claim 15, wherein said mounting portion is configured to engage said object.

17. The system of claim 1, in which said lifting assembly comprises a carrying portion.

18. The system of claim 17, wherein said carrying portion is configured to be operable to transport said lifting assembly.

19. A system comprising:
means for positioning a lifting assembly in proximity to an object;
means for joining a handle portion with a lift portion;
means for manipulating said lift portion with said handle portion;
means for detaching said handle portion from said lift portion;
means for joining said handle portion with a handle storage portion;
means for storing said lifting assembly.

20. A system consisting of:
a lifting assembly, said lifting assembly comprising a pneumatic jack, said lifting assembly being configured to apply a force on an object, said lifting assembly comprising a base portion, said base portion being configured to rest on a surface, said base portion comprising a threaded female section, said lifting assembly further comprising a mounting portion, said mounting portion being configured to engage said object, said lifting assembly further comprising a lift portion, said lift portion being configured to operate said lifting assembly, said lifting assembly further comprising a carrying portion, said carrying portion being configured to be operable to transport said lifting assembly, said lifting assembly further comprising a handle storage portion, said handle storage portion comprising a solid rod, said handle storage portion being configured to extend from said base portion, said handle storage portion further comprising a protruding portion, said protruding portion comprising a spring loaded tab, said handle storage portion comprising a threaded neck section, said threaded neck section being configured to be urged through said threaded female section; and
a handle portion, said handle portion comprising a hollow rod, said handle portion further comprising an aperture, said aperture being configured to at least partially receive said protruding portion, said handle portion being configured to detachably join with said lift portion, said handle portion being operable to manipulate said lift portion, said handle portion further being configured to detachably join with said handle storage portion.
